(19) United States
(12) Patent Application Publication
(10) Pub. No.: US 2014/0323159 A1
(43) Pub. Date: Oct. 30, 2014

(54) METHOD AND SYSTEM FOR PROVIDING RELEVANT INFORMATION TO A MOBILE DEVICE

(71) Applicants: Srinivasan Ramaswamy, Ottawa (CA); David Steer, Nepean (CA)

(72) Inventors: Srinivasan Ramaswamy, Ottawa (CA); David Steer, Nepean (CA)

(73) Assignee: ROCKSTAR CONSORTIUM US LP, Plano, TX (US)

(21) Appl. No.: 14/357,096

(22) PCT Filed: Nov. 9, 2011
(86) PCT No.: PCT/US2011/059969

§ 371 Date: May 8, 2014

(51) Int. Cl. H04W 4/02

(52) U.S. Cl. CPC H04W 4/023; H04W 88/02
USPC 455/456.3

(57) ABSTRACT

A method and system for providing relevant information to a mobile device. An entity structure is provided that includes entity records, each entity record corresponding to an entity that provides a service. Each entity record is associated with a proper subset of regions of a plurality of regions and is categorized into at least one category of a plurality of categories based on the service provided by the entity. A first region category index that is based on the entity structure is provided to a mobile device that is determined to be in a first region of the plurality of regions. The first region category index identifies only those categories in which at least one entity record associated with the first region has been categorized.

### FIELD OF THE DISCLOSURE

The present disclosure relates generally to providing information to a mobile device, and in particular to providing relevant information to a mobile device based on a location of the mobile device.

### BACKGROUND

Directories exist that identify services and related information, such as addresses and phone numbers of the services. Such directories enable a user to locate a desired service, such as a restaurant or towing service, from a list of such services. However, it can be time-consuming for the user to determine which particular service is best suited to a user's needs, because the list of relevant services, by itself, must typically be analyzed by the user in order to select the best such service for the user. For example, the user may have to consult a map to determine where each such service is, and may have to contact such services directly to determine which of the services are currently open for business. Where the service is mobile, such as a towing service, the user has to determine whether the towing service operates in the relevant geographic area of the user.

These problems are compounded when a user is travelling in a location with which the user is unfamiliar. Street addresses are of little use to a user unfamiliar with the streets of a rarely visited town. The user must access a map to determine where a service is located, determine if the service is open for business, and the like. This can not only be time-consuming, but in a location unfamiliar to the user, may present safety problems when a user inadvertently stops a vehicle in an unsafe location in order to interact with a mapping function of a mobile device to locate a desired service.

Accordingly, there is a need for a mechanism that provides relevant information to a mobile device that eliminates, or at least greatly reduces, the need for the user to analyze the information in order to select a desired service.

### SUMMARY

Embodiments of the present disclosure relate to providing relevant information about service-providing entities to a user who is in a particular geographic region. In one embodiment, an entity structure comprises a plurality of entity records. Each entity record corresponds to an entity that provides a service, such as a retailer, a hair salon, a towing company, or the like. Each entity record also corresponds to a proper subset of regions of a plurality of geographic regions. Each entity record is categorized into at least one category of a plurality of categories, based on the particular service provided by the entity that corresponds to the entity record. It is determined that the user is in a first region of the plurality of regions. A first region category index that identifies only those categories in which at least one entity record associated with the first region has been categorized is sent to a mobile device of the user.

The mobile device presents the first region category index to the user. The presentation may be via a display, may be audibly presented directly by the mobile device, or may be audibly presented by an audio system of a vehicle to which the mobile device is communicatively coupled. The first region category index includes category entries relevant to the first region. Each category entry identifies a category and contains a reference to one or more other category entries, such as subcategory entries, or to a list of entities that have been categorized into the category. Notably, only categories that include entities associated with the first region are presented to the user, eliminating the need for the user to filter out entities that are not in geographic proximity to the user.

In one embodiment, the entity records further include entity availability data identifying operating hours of the corresponding entity. A current time is determined prior to providing the first region category index to the mobile device. The first region category index identifies only those categories in which at least one entity record associated with the first region has been categorized and in which the at least one entity record contains service availability data that indicates that the corresponding entity is operating at the current time.

The user may select a category and be presented with other categories, such as subcategories, or be presented with one or more entity identifiers that identify entities that have an entity record in the entity structure. As noted above, each entity identified by an entity identifier presented to the user is associated with the first region, and optionally, may also be presented only if the entity record indicates that the entity is open for business at the current time. Thus, the user need not expend time determining whether entities are open, or are in proximity to the user.

As the mobile device leaves the first region and enters a second region, a second region category index is sent to the mobile device, and the first region category index is preferably deleted. The second region category index identifies only those categories in which at least one entity record associated with the second region has been categorized, and optionally, in which the entities associated with the at least one entity record are open for business at the current time. Thus, as the user travels through the plurality of regions, the mobile device is repeatedly provided with region category indexes that identify only those entities that are associated with the region in which the user is presently located.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates a system in which embodiments of the present disclosure may be practiced;

FIG. 2 illustrates exemplary screen displays in which a first region category index may be presented to a user, according to one embodiment;

FIG. 3 is a message flow diagram illustrating an exemplary message flow between various components illustrated in FIG. 1 to provide relevant information to a mobile device according to one embodiment;

FIG. 4 is a block diagram illustrating the entity structure illustrated in FIG. 1 in greater detail;

FIG. 5 is a message flow diagram illustrating an exemplary message flow between various components of the system during a modification of an entity record according to one embodiment;

FIG. 6 is a block diagram illustrating the generation of an exemplary local index structure (LIS) and an entity reference structure (ERS) according to one embodiment;

FIG. 7 is a block diagram of another embodiment of the system illustrated in FIG. 1; and

FIG. 8 is a block diagram of an exemplary computing device suitable for implementing the server illustrated in FIG. 1, according to one embodiment.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

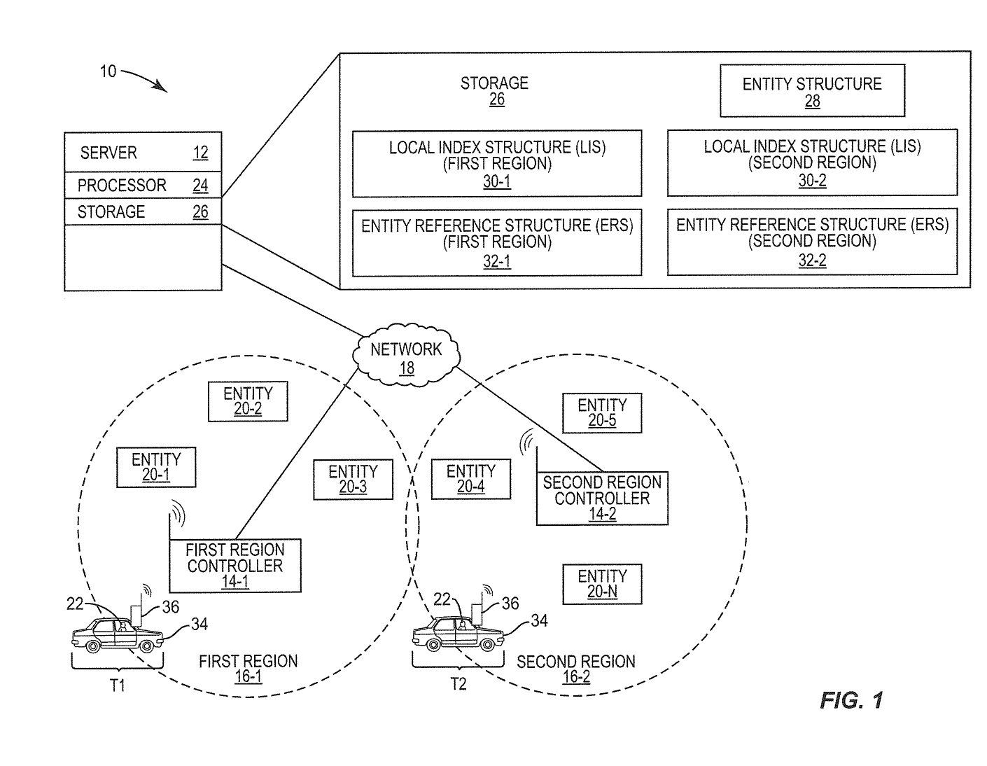

FIG. 1 illustrates a system 10 in which embodiments of the present disclosure may be practiced. The system 10 includes a server 12, a first region controller 14-1 that is associated with a first region 16-1, and a second region controller 14-2 that is associated with a second region 16-2. The first and second region controllers 14-1, 14-2 may be referred to herein generally as the region controllers 14. Similarly, the first and second regions 16-1, 16-2 may be referred to herein generally as the regions 16. The first region 16-1 is a geographic region that may be defined in any suitable manner, such as, for example, by longitude and latitude coordinates and a radius; by one or more zip codes; by streets or other identifiable features that border the first region 16-1; or by a wireless coverage area of a wireless communication controller, such as a Wi-Fi® access point or the like. In one embodiment, the first region controller 14-1 comprises a cellular controller, and the first region 16-1 is defined by the wireless coverage area of the first region controller 14-1. In particular, the first region controller 14-1 comprises equipment suitable for providing cellular data service, such as 2G, 3G, or 4G cellular data service, in the first region 16-1. Depending on the particular technology used, which is system dependent, the first region controller 14-1 may comprise, for example, a base station; an antenna; and a computing device, which may be separate from the base station or integral with the base station to provide additional functionality as described herein.

The second region controller 14-2 may also comprise a cellular controller, and may be configured in a manner similar to that described above with respect to the first region controller 14-1. The wireless coverage area of the second region controller 14-2 may define the boundaries of the second region 16-2. While for purposes of illustration only two region controllers 14 are shown, it will be apparent that the cellular system of which the region controllers 14 are a part may comprise a relatively large number of regions 16, and therefore have a relatively large number of corresponding region controllers 14, all of which may operate similarly or identically to the manner in which the first and second region controllers 14-1, 14-2 are described herein. The region controllers 14 are communicatively coupled to the server 12 via a network 18, which may comprise a private network, a public network, or a combination thereof.

A plurality of entities 20-1-20-N (generally, entities 20) are located in the first and second regions 16. The entities 20 each provide a service that may be utilized by a user 22. The services provided may include, for example, the sale of goods, such as those sold by a big box retailer entity 20; haircutting services, such as those offered by a hair salon entity 20; a towing service, such as that offered by a towing service entity 20; the display of art, such as that offered by an art museum entity 20; or the like. The term “service” is meant to encompass any item or action offered by an entity 20 that may be useful to a user 22.

Each of the entities 20 is associated with a proper subset of regions 16 of the plurality of regions 16. The association may be based on either a location of the entity 20 or a service area of the entity 20. For example, the entities 20-1-20-3 may all be physically located in the first region 16-1 and offer services, such as the sale of goods, at their physical locations. The entity 20-4 may comprise, for example, a towing service whose coverage area includes the second region 16-2, as well as other regions 16 (although not the first region 16-1).

The server 12 comprises a computing device that includes a processor 24 and a storage 26 for storing data. The storage 26 includes one or more data structures that contain information about the entities 20. In particular, the storage 26 includes an entity structure 28 that contains a plurality of entity records, each entity record corresponding to one of the entities 20. As will be discussed in greater detail herein, each entity record includes information about the entity 20 to which the entity record corresponds, such as entity location data identifying a location of the entity 20; entity service area data identifying a service area of the entity 20 for those entities 20 that provide mobile services, such as towing services, to one or more regions 16; entity availability data identifying operating hours of the entity 20, and the like.

Each entity record may be categorized into one or more categories based on the service provided by the entity 20 that corresponds to the entity record. The particular categorization used may be system dependent. For example, categories may include a restaurant category, an entertainment category, a bank category, and the like. Each category may be further categorized into additional categories, sometimes referred to herein as subcategories. For example, the restaurant category may include a French restaurant category, an American restaurant category, and an Italian restaurant category. The particular categorization of an entity record may be maintained in the entity record itself, and as discussed in greater detail herein, may be provided by a service provider associated with the server 12, or by an individual associated with the entity 20 that corresponds to the entity record.

In one embodiment, the storage 26 also includes several structures that are associated with particular regions 16. In particular, the storage 26 includes a local index structure (LIS) 30-1 that is associated with the first region 16-1. The LIS 30-1 contains a plurality of category entries, each of which is associated with a particular category of at least one entity record in the entity structure 28 that is identified as being associated with the first region 16-1. In one embodiment, each category entry either refers to one or more other category entries, such as subcategory entries, or contains an entity list reference that refers to an entity list in an entity reference structure (ERS) 32-1. Preferably, the LIS 30-1 contains category entries for only those categories that are relevant to the first region 16-1 based on entity records in the entity structure 28 that are identified as being associated with the first region 16-1. For example, if the entity structure 28 contains no entity records that are associated with the first region 16-1 and which are categorized as an Italian restaurant, then the LIS 30-1 would not contain an “Italian restaurant” category entry.

The ERS 32-1 corresponds to the first region 16-1, and, as discussed in greater detail herein, contains lists of entity references, each of which refers to a particular entity record in the entity structure 28 that is identified as being associated with the first region 16-1. Similarly, an LIS 30-2 contains category entries that identify those categories in which entity records in the entity structure 28 that have been identified as being associated with the second region 16-2 have been categorized. The ERS 32-2 contains lists of entity references that refer to entities that are identified as being associated with the second region 16-2.

An example of providing relevant information to a mobile device according to one embodiment will now be discussed. Assume that the user 22 is travelling in a vehicle 34, and has a mobile device 36 capable of wireless communications with the first region controller 14-1. For example, the user 22 may have a cellular telephone subscription with a regional or national service provider that offers cellular voice and data services via the server 12 and region controllers 14. Assume that at a time T1, the vehicle 34 enters the first region 16-1. The mobile device 36 may comprise, for example, a smartphone, essentially a pocket-sized computing device that implements both voice capabilities and data processing capabilities, such as the Apple® iPhone® or an Android™-based smartphone. The mobile device 36 may execute a traveler application that, in conjunction with the functionality described herein with respect to the server 12 and region controllers 14, implements aspects of the embodiments described herein. In other embodiments, the mobile device 36 may comprise a laptop computer or a tablet computer, such as an Apple® iPad® or an Android™-based tablet computer.

In one embodiment, the mobile device 36 is aware it has entered the first region 16-1 as part of the normal signaling associated with the hand-off of the mobile device 36 from one region controller 14 to another region controller 14. Upon determining it has entered the first region 16-1, the mobile device 36 obtains, via the first region controller 14-1, a first region category index that contains category entries of those categories in which at least one entity record in the entity structure 28 that is associated with the first region 16-1 has been categorized. The first region category index is based on, i.e., generated from, the LIS 30-1. Similar to the LIS 30-1, each category entry in the first region category index either refers to one or more other category entries, such as subcategory entries, or contains an entity list reference that refers to an entity list in the ERS 32-1. The first region category index may be identical to the LIS 30-1, or, as described in greater detail herein, may be a subset of the LIS 30-1.

The mobile device 36 may obtain the first region category index by requesting the first region category index from the server 12 via the first region controller 14-1. Alternately, by convention, each region controller 14 may continually broadcast a corresponding region category index associated with the respective region controller 14 on a predetermined broadcast channel to which the mobile device 36 listens. As will be discussed in greater detail below, updates to the first region category index may also be broadcast on the predetermined broadcast channel. Those of skill in the art will appreciate that other mechanisms may be employed to communicate the first region category index to the mobile device 36 in conjunction with the mobile device 36 entering the first region 16-1.

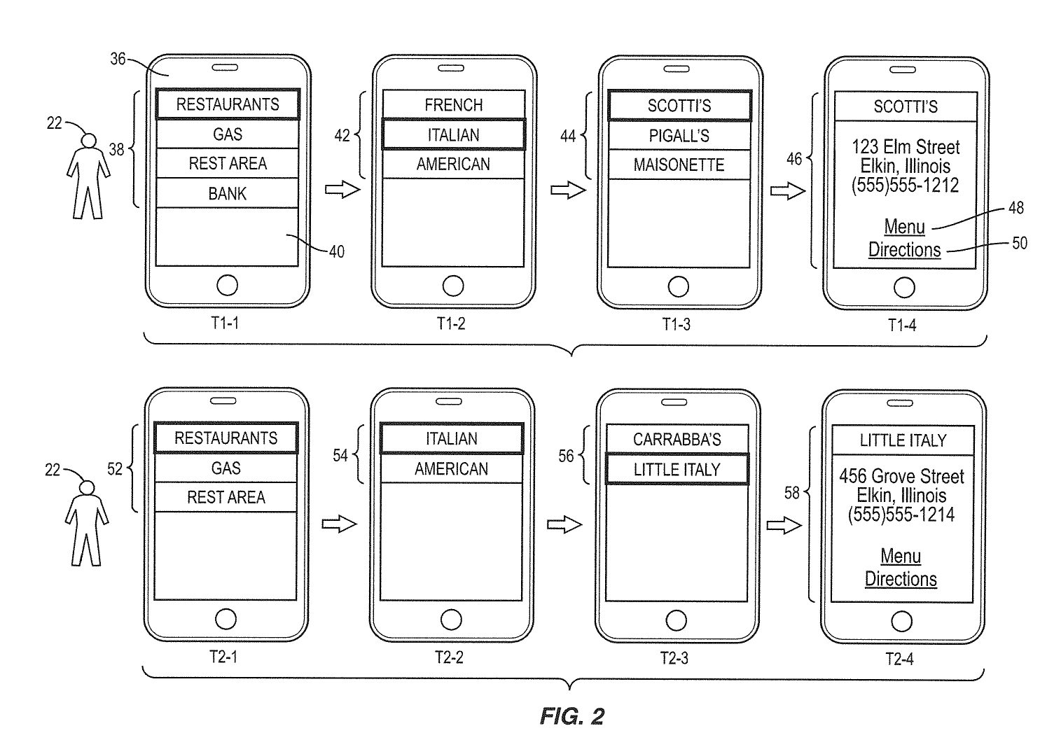

FIG. 2 illustrates exemplary user interfaces in which the first region category index may be presented to the user 22, according to one embodiment, and will be discussed in conjunction with FIG. 1. When the mobile device 36 receives the first region category index, the mobile device 36 formats the first region category index for presentation to the user 22, and presents the formatted category index in a user interface 38 to the user 22, as illustrated at time T1-1 (FIG. 2). The user interface 38 may depict a restaurants category, a gas category, a rest area category, and a bank category, for example. While the functionality herein will be ascribed to the mobile device 36 for purposes of illustration, the functionality may be implemented by the mobile device 36 through a particular application that executes on the mobile device 36, such as the traveler application discussed above. While FIG. 2 illustrates a visual user interface, the first region category index could be presented to a user 22 via an audio user interface via the mobile device 36, either directly or via an audio system of the vehicle 34 to which the mobile device 36 is communicatively coupled, such as via Bluetooth® or the like. The audio interface may include a speech recognition interface that allows the user 22 to navigate the first region category index via voice commands.

Assume that the mobile device 36 comprises a touch-sensitive surface 40, and that the user 22 selects the restaurants category in the user interface 38. In response, the mobile device 36 accesses the restaurant category entry in the first region category index and determines that the restaurant category entry refers to other category entries, in particular subcategory entries for a French restaurant category, an Italian restaurant category, and an American restaurant category. The mobile device 36 formats and presents this information to the user 22 in a user interface 42. Note that the entity structure 28 may contain entity records that correspond to entities 20 that are categorized in other restaurant categories, such as a Chinese restaurant category or a Mexican restaurant category. The absence of such category entries in the first region category index indicates that none of such entities 20 is associated with the first region 16-1, or if associated with the first region 16-1, these entities 20 are not currently open for business. Thus, the user 22 is presented only with those categories in which an entity 20 associated with the first region 16-1 has been categorized, and optionally, only where such entities 20 are also currently open for business at time T1-2.

Assume that the user 22 selects the Italian restaurant category via the touch-sensitive surface 40. In response, the mobile device 36 accesses the first region category index and determines that the Italian restaurant category entry contains an entity list reference that refers to an entity list in the ERS 32-1. The mobile device 36 requests the referenced entity list from the ERS 32-1. The entity list contains entity identifiers and corresponding entity references to entity records in the entity structure 28. The mobile device 36 formats the entity list, and presents the entity identifiers in a user interface 44 to the user 22, as shown at time T1-3. Assume that the user 22 selects the Scotti's entity identifier via the touch-sensitive surface 40. In response, the mobile device 36 accesses the entity reference associated with the Scotti's entity identifier, and requests the entity record referred to by the entity reference from the entity structure 28. The entity record, or a summary of some or all of the information in the entity record, is provided to the mobile device 36. The mobile device 36 presents the information to the user 22 in a user interface 46, as shown at time T1-4.

The entity record may include links, such as links 48 and 50, which, when selected by the user 22, access information, such as a menu of Scotti's, or a list of directions to Scotti's, which may then be presented to the user 22.

Referring again to FIG. 1, assume that the vehicle 34 enters the second region 16-2 at a time T2. The mobile device 36 may delete the first region category index and obtain a second region category index that identifies categories in which entity records in the entity structure 28 that are associated with the second region 16-2 have been categorized. Referring again to FIG. 2, assume that the mobile device 36 formats the second region category index and presents it in a user interface 52 as illustrated at time T2-1. Note that the categories do not include a bank category as was presented to the user 22 in the user interface 38 at time T1-1. This is because either the second region 16-2 does not contain a bank entity, or no bank entity in the second region 16-2 is currently open for business. User interfaces 54, 56, and 58, illustrated at times T2-2, T2-3, and T2-4, respectively, illustrate another exemplary sequence of selections by the user 22, and responses thereto by the mobile device 36.

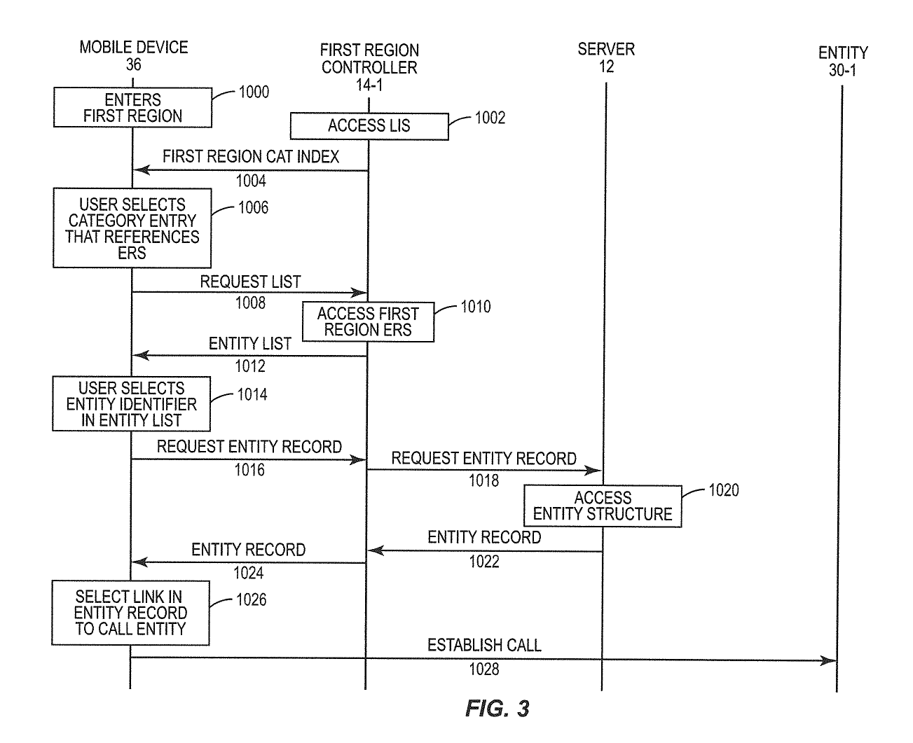

FIG. 3 is a message flow diagram illustrating an exemplary message flow between various components illustrated in FIG. 1 to provide relevant information to the mobile device 36 according to one embodiment. FIG. 3 will be discussed in conjunction with FIG. 1. The mobile device 36 enters the first region 16-1 (step 1000). In this embodiment, assume that the first region controller 14-1 recognizes this based on the normal cellular handoff communications that occur as the mobile device 36 moves from one cell region to another cell region. In this embodiment, the first region controller 14-1 accesses the LIS 30-1, generates a first region category index, and sends the first region category index to the mobile device 36 (steps 1002-1004). Alternatively, the first region category index may be pre-generated based on the LIS 30-1, or may simply comprise the LIS 30-1. Note that the LIS 30-1 may be stored on the server 12, in which case the first region controller 14-1 may access the LIS 30-1 by communicating with the server 12, although these communications are not illustrated in FIG. 3. In another embodiment, the LIS 30-1 and the ERS 32-1 are stored locally on the first region controller 14-1.

Assume that the user 22 ultimately selects a category entry that contains an entity list reference that refers to an entity list in the ERS 32-1 (step 1006). The mobile device 36 sends a message to the first region controller 14-1 for the referenced entity list (step 1008). The first region controller 14-1 accesses the ERS 32-1 and obtains the referenced entity list (step 1010). The first region controller 14-1 provides the referenced entity list to the mobile device 36 (step 1012). The mobile device 36 presents entity identifiers identifying the entities in the entity list to the user 22. The user 22 selects a particular entity identifier (step 1014). Assume that the selected entity identifier corresponds to the entity 20-1. The mobile device 36 requests the entity record corresponding to the selected entity (i.e., the entity 20-1) (steps 1016-1018). The server 12 accesses the entity structure 28 and returns the entity record, or information obtained from the entity record, to the mobile device 36 (steps 1020-1024). The mobile device 36 presents the information from the entity record to the user 22. The information includes a link which, when selected by the user 22, initiates a telephone call with the entity 20-1. The user 22 selects the link (step 1026) and establishes a telephone call with the entity 20-1 (step 1028).

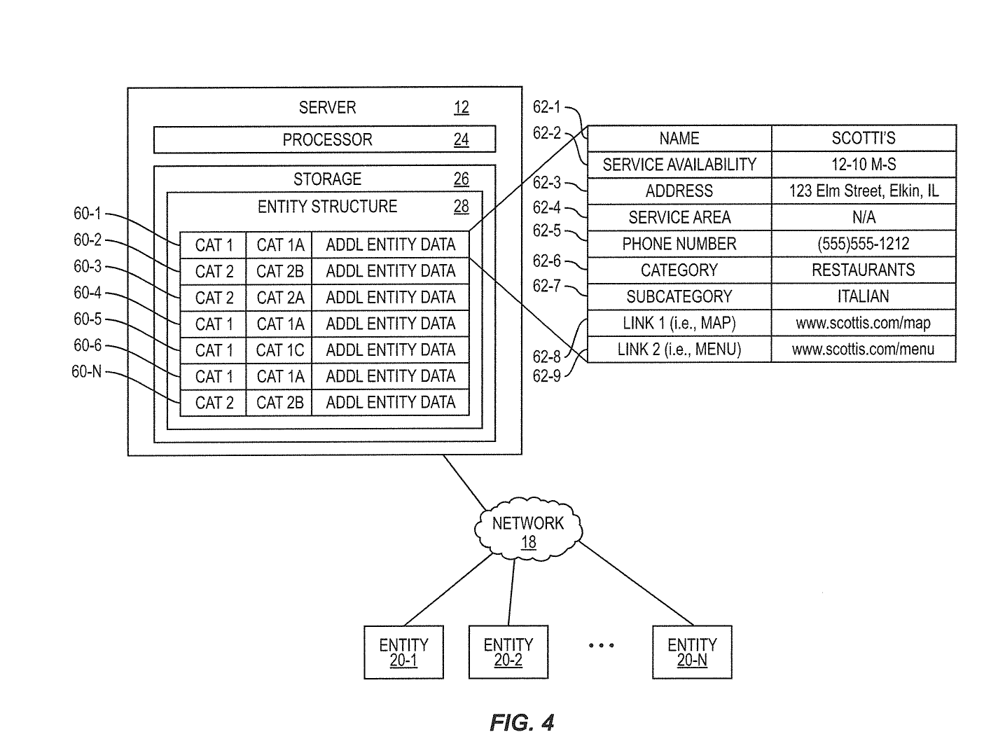

FIG. 4 is a block diagram illustrating the entity structure 28 illustrated in FIG. 1 in greater detail. The entity structure 28 comprises a plurality of entity records 60-1-60-N (generally, entity records 60), each of which corresponds to a different entity 20. Each entity record 60 may be categorized into one or more categories. In one embodiment, a service provider associated with the server 12 may enable the entities 20 to create, update, or delete a corresponding entity record 60 from the entity structure 28 via the network 18. In particular, the service provider may, upon request, provide an entity 20 with a software application which, when downloaded onto a computing device associated with the entity 20, allows the entity 20 to modify the entity structure 28. Such access may be provided in conjunction with a paid service, wherein for a fee, the entity 20 is permitted to generate a corresponding entity record 60 in the entity structure 28. In one embodiment, upon registration for the service, the service provider may provide the entity 20 with a uniform resource locator (URL) which links to a web application that provides a user interface to enable the entity 20 to generate, update, or delete a corresponding entity record 60.

The web application may provide a user interface that requests information from the entity 20 and thereby gathers the appropriate data to populate data fields in the corresponding entity record 60. Such information may include categories in which the corresponding entity record 60 should be categorized, thereby facilitating the categorization of the entity record 60 by the entity 20. A name field 62-1 may identify a name of the entity 20. A service availability field 62-2 may identify the hours during with the entity is open for business. An address field 62-3 may identify an address at which the entity 20 is located. A service area field 62-4 may be used for those entities 20 that offer mobile services, such as a towing service, and may identify service areas. A phone number field 62-5 may identify a phone number of the entity 20. One or more category fields 62-6-62-7 may be used by the entity 20 to categorize the service offered by the entity 20. Link fields 62-8-62-9 may contains links, such as URLs, which, when selected by a user 22, cause the delivery of web pages containing particular information, such as a menu of the entity 20 or a map to the entity 20. It will be appreciated that the fields 62 are merely representative, and any desired information about an entity 20 may be stored in an entity record 60.

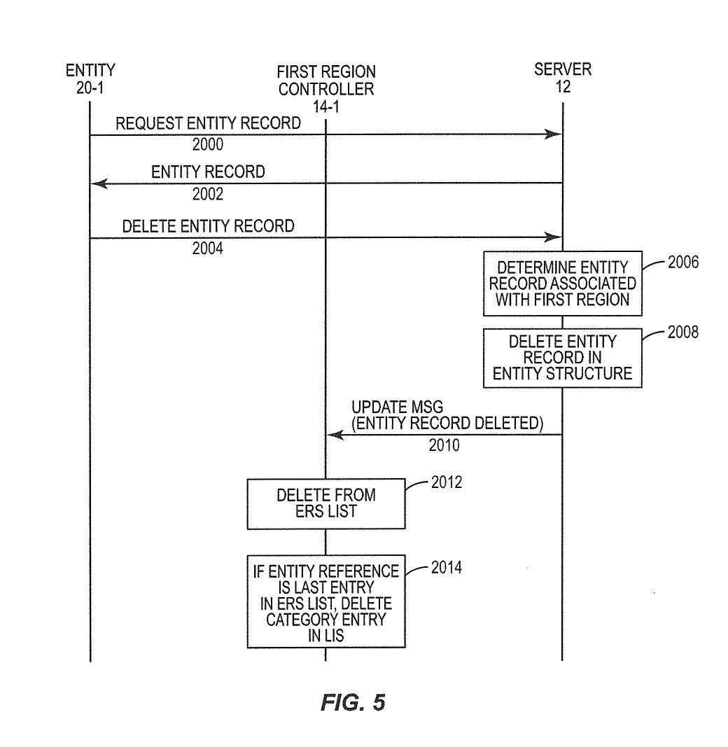

FIG. 5 is a message flow diagram illustrating an exemplary message flow between various components of the system 10 during a modification of an entity record 60 according to one embodiment. Assume that the entity 20-1 desires to delete the corresponding entity record from the entity structure 28. The entity 20-1 initiates a web application on a computing device that interfaces with the server 12 via the network 18, and requests the entity record associated with the entity 20-1 (step 2000). The server 12 obtains the requested entity record and provides it to the entity 20-1 (step 2002). The entity 20-1 deletes the entity record (step 2004). The server 12 determines that the deleted entity record is associated with the first region 16-1, and deletes the entity record (steps 2006-2008). The server 12 then sends an update message to the first region controller 14-1 indicating that the entity record has been deleted (step 2010). The first region controller 14-1 deletes the entity reference to the entity record from the ERS 32-1, and if the entity reference was the last entity reference in an entity list in the ERS 32-1, the first region controller 14-1 deletes the category entry in the LIS 30-1 that referred to the entity list (steps 2012-2014).

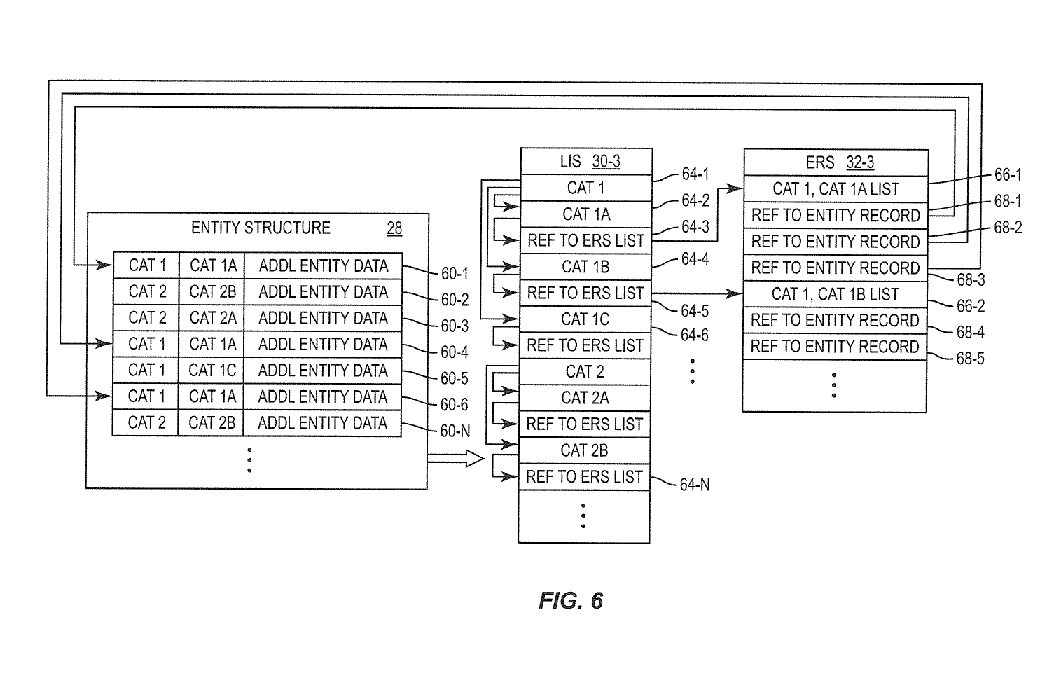

FIG. 6 is a block diagram illustrating the generation of an exemplary LIS 30-3 and an ERS 32-3 according to one embodiment. A computing device, such as the server 12 or another processing device, accesses the entity structure 28 and processes the entity record 60-1. The computing device determines if the entity record 60-1 corresponds to an entity 20 that has an association with the region with which the LIS 30-3 corresponds. For purposes of illustration, assume that the LIS 30-3 is associated with a third region (not shown). The association with the third region may be through either the address field 62-3, if the address of the entity 20 is within the third region, or the service area field 62-4, if the entity 20 offers services in the third region. The computing device processes each entity record 60 similarly. Based on the entity records 60 that correspond to entities 20 that are associated with the third region, the computing device generates the LIS 30-3, which contains a plurality of category entries 64-1-64-N (generally, category entries 64), and the ERS 32-3, which contains a plurality of entity reference lists 66-1-66-N (generally, entity reference lists 66), each of which contains one or more entity references 68 which refer to an entity record 60 in the entity structure 28.

In particular, as the computing device processes each entity record 60, it is determined whether the LIS 30-3 already contains one or more category entries 64 that correspond to the categorization of the entity record 60. If not, the computing device generates the appropriate category entries 64 in the LIS 30-3. The computing device also determines whether an entity reference list 66 for the particular category exists in the ERS 32-3. If not, the computing device generates an entity reference list 66 in the ERS 32-3. The computing device then generates an entity reference 68 in the appropriate entity reference list 66 that points to the entity record 60.

The LIS 30-3 and the ERS 32-3 illustrated in FIG. 6 reflect exemplary structures after the computing device has processed the entity records 60-1-60-N. The LIS 30-3 contains a category entry 64-1 which refers to three other category entries 64-2, 64-4, and 64-6. For example, category entry 64-1 may be a restaurant category, and the category entries 64-2, 64-4, and 64-6 may be an Italian restaurant subcategory, a French restaurant subcategory, and an American restaurant subcategory, respectively. The category entry 64-3 contains an entity list reference which refers to the entity reference list 66-1 in the ERS 32-3. The entity reference list 66-1 contains a plurality of entity references 68-1-68-3, which refer to entity records 60 in the entity structure 28 that are categorized into the category associated with the category entry 64-3. As discussed above, the LIS 30-3 only contains category entries 64 comprising categories for entity records 60 that correspond to the third region. Thus, the LIS 30-3 contains category entries 64 that are unique, or customized, to the third region. In this manner, a region category index that identifies only those categories of entities that are in the third region can be provided to a mobile device 36 (FIG. 1) in the third region.

As discussed previously, a region category index provided to a mobile device 36 that has entered a region may be the same as the LIS 30 for that region, or may be different from the LIS 30. In one embodiment, the region category index may differ based on preference information associated with the user 22 (FIG. 1) of the mobile device 36. For example, referring again to FIG. 1, preference information associated with the user 22 may indicate that the user 22 prefers French restaurants, and is not interested in Chinese restaurants. When the mobile device 36 enters the first region 16-1, the region category index may be generated based on both the LIS 30-1 and such known preferences, such that French restaurants are listed first, and Chinese restaurants, even if associated with the first region 16-1, are not shown to the user 22. This may be referred to as a first phase of filtering based on the user preferences of the user 22. In another example, the user preferences may indicate that the user 22 is a French-speaking individual and prefers the French language, and the region category index may therefore be generated in the French language. If no preferences are known about the user 22, the region category index may be the LIS 30 itself.

A second phase of filtering based on user preferences may be applied to entity lists maintained in an ERS 32 prior to providing such lists to the mobile device 36. Using the example above, it may be known that the user 22 prefers highway travel to rural road travel, and the entity identifiers of Italian restaurants presented to the user 22 may be based on the restaurants' current proximity to the user 22 based on highway travel versus travel via rural roads. Thus, one restaurant that is farther from the user 22 may be listed above another restaurant that is closer to the user 22 because directions to the former restaurant from the current location of the user 22 involve fewer rural roads than directions to the latter restaurant. Other examples include filtering or sorting entity identifiers based on hotel preferences, such as a user preference for 5-star-rated hotels versus 4-star-rated hotels, and user preferences for premium gas versus regular gas may be used to sort, or eliminate, certain gas stations from an entity list of gas stations in the relevant region. It will be appreciated that these are merely exemplary, and that the potential filtering and sorting that may be performed based on user preferences is not limited to such examples.

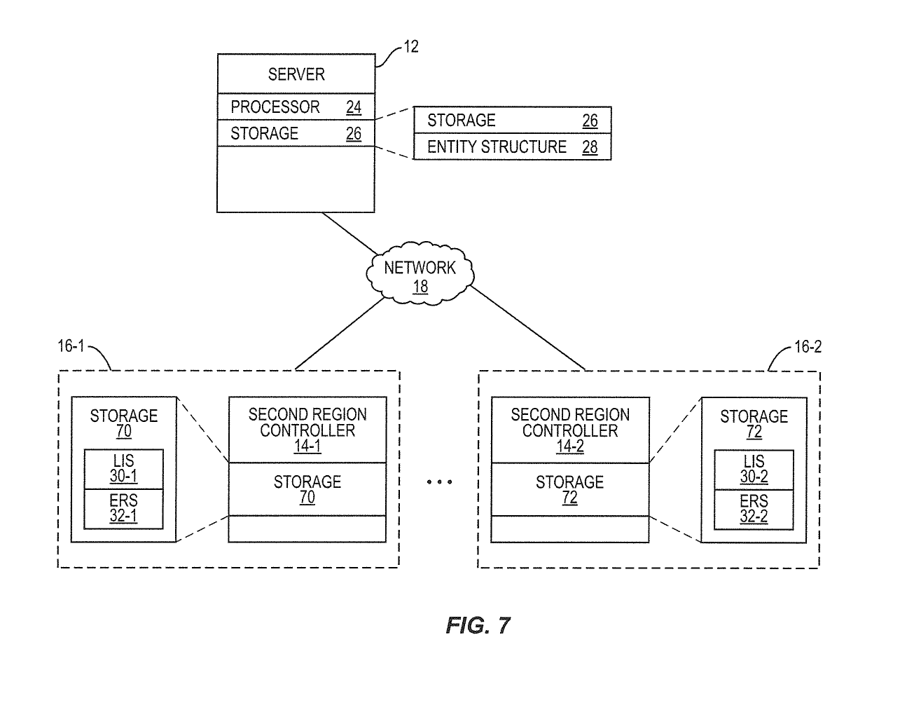

FIG. 7 is a block diagram of another embodiment of the system 10 illustrated in FIG. 1. Referring first to FIG. 1, it will be noted that the entity structure 28, LISs 30 and ERSs 32 were maintained in the server 12. In such embodiment, a region controller 14 accesses a corresponding LIS 30 and ERS 32 via communications over the network 18. Such access may be indirect, through the server 12, where a region controller 14 passes all requests for access to an LIS 30 or ERS 32 to the server 12, which in turn accesses the requested structure and returns the requested information to the LIS 30. Or, the region controller 14 may be able to access the LIS 30 or ERS 32 directly, via the network 18. In either event, while the manner in which the LIS 30 and ERS 32 are accessed is transparent to the user 22, such access may cause delay that is inherent in communications over the network 18.

In the embodiment illustrated in FIG. 7, the LISs 30 and ERSs 32 are distributed to the region controllers 14 to which the LISs 30 and ERSs 32 correspond. Thus, the first region controller 14-1 includes a storage 70 in which the LIS 30-1 and the ERS 32-1 are stored. The second region controller 14-2 includes a storage 72 in which the LIS 30-2 and the ERS 32-2 are stored. In this embodiment, when the mobile device 36 enters the first region 16-1, the first region controller 14-1 can generate a region category index without needing to access the network 18. However, the first region controller 14-1 may still communicate with the server 12 for additional information, such as the user preferences of the user 22, for purposes of first- and second-phase filtering, as discussed above.

In one embodiment, the entity structure 28 continuously generates update information based on the data in the entity records 60 in the entity structure 28, and transmits data identifying the update information to affected LISs 30 and ERSs 32. Such update information, as discussed above, may relate to modifications made to an entity record 60, such as the addition of a new entity record 60 or deletion of a new entity record 60. Other updates may occur automatically due to information contained in an entity record 60, such as information in the service availability field 62-2 (FIG. 4). For example, in one embodiment, an update may be triggered based on a time of day.

In particular, a determination that an entity 20 has closed for the day based on the service availability field 62-2 of the corresponding entity record 60 may trigger a message to the LIS 30-1 and the ERS 32-1 indicating that the corresponding entity 20 is no longer open for business. In response, any entity reference list 66 in the ERS 32-1 that contains an entity reference 68 to the corresponding entity record 60 is removed from the list, so that an entity identifier identifying the entity 20 will not be presented to the user 22. If the entity reference 68 was the only entity reference in the entity reference list 66, the entity reference list 66 will be deleted from the ERS 32-1, and the LIS 30-1 will be modified to remove the category entry 64 that refers to such entity reference list 66, so the user 22 will no longer be presented with that category entry 64.

The reverse process may occur at the time of day when the entity 20 opens for business. For example, if the service availability field 62-2 indicates that the business opens at 7:00 a.m., at 7:00 a.m. an update will be triggered and sent to the LIS 30-1 and the ERS 32-1 indicating that the entity 20 corresponding to the entity record 60 is now open for business. In response, the ERS 32-1 will add an entity reference 68 to the appropriate entity reference list 66, and, if necessary, a category entry 64 will be generated in the LIS 30-1. In this manner, the region category index provided to the user 22 will contain categories of only those entities 20 that are associated with the first region 16-1 and that are indicated as being open for business at the current time. While for purposes of illustration the updates have been described as being sent directly to the LIS 30-1 and the ERS 32-1 and processed by such structures, it will be apparent that depending on the manner in which the LIS 30-1 and the ERS 32-1 are maintained, the updates may be sent to a particular computing device, such as the first region controller 14-1, for application to the LIS 30-1 and the ERS 32-1.

In another embodiment, data contained in the entity records 60 may be updated automatically, and may be available for display to the user 22 upon selection of an entity reference 68 that refers to the entity record 60. For example, a ski resort may install weather-sensing equipment that periodically and automatically, without human involvement, updates a weather condition field via the network 18 in an entity record 60 that corresponds to the ski resort. In this manner, the user 22 may be presented with the actual weather conditions at the ski resort. In another embodiment, a gas station entity 20 may install equipment that automatically updates a corresponding entity record 60 with the current prices of each grade of gasoline sold by the gas station, so the user 22 may be presented with the current gas prices of the gas station.

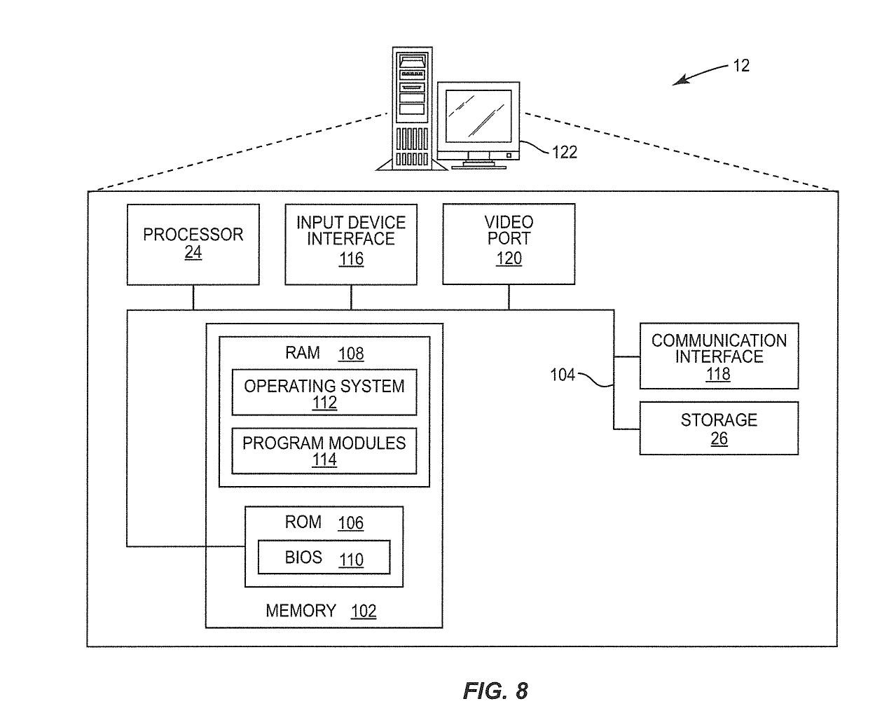

FIG. 8 is a block diagram of an exemplary computing device suitable for implementing the server 12, according to one embodiment. The server 12 may comprise a workstation, a telecommunications switch, or the like. The server 12 includes the processor 24, a system memory 102, and a system bus 104. The system bus 104 provides an interface for system components including, but not limited to, the system memory 102 and the processor 24. The processor 24 can be any of various commercially available or proprietary processors. Dual microprocessors and other multi-processor architectures may also be employed as the processor 24.

The system bus 104 may be any of several types of bus structures that may further interconnect to a memory bus (with or without a memory controller), a peripheral bus, and/or a local bus using any of a variety of commercially available bus architectures. The system memory 102 may include non-volatile memory 106 (e.g., read only memory (ROM), erasable programmable read only memory (EPROM), electrically erasable programmable read only memory (EEPROM), etc.) and/or volatile memory 108 (e.g., random access memory (RAM)). A basic input/output system (BIOS) 110 may be stored in the non-volatile memory 106, and can include the basic routines that help to transfer information between elements within the server 12. The volatile memory 108 may also include a high-speed RAM such as static RAM for caching data.

The server 12 may further include the computer-readable storage 26, which may comprise, for example, an internal hard disk drive (HDD) (e.g., enhanced integrated drive electronics (EIDE) or serial advanced technology attachment (SATA)) HDD (e.g., EIDE or SATA) for storage, flash memory, or the like. The storage 26 may store, for example, the entity structure 28, LISs 30, and ERSs 32. The drives and associated computer-readable and computer-usable media provide non-volatile storage of data, data structures, computer-executable instructions, and so forth. Although the description of computer-readable media above refers to an HDD, it should be appreciated by those skilled in the art that other types of media which are readable by a computer, such as Zip disks, magnetic cassettes, flash memory cards, cartridges, and the like, may also be used in the exemplary operating environment, and further, that any such media may contain computer-executable instructions for performing novel methods of the disclosed architecture.

A number of program modules can be stored in the storage 26 and in the volatile memory 108, including an operating system 112 and one or more program modules 114, which may implement the functionality described herein in whole or in part, including, for example, functionality described with respect to generating the LISs 30 and the ERSs 32, and other processing and functionality described herein. It is to be appreciated that the embodiments can be implemented with various commercially available operating systems 112 or combinations of operating systems 112.

All or a portion of the embodiments may be implemented as a computer program product stored on a non-transitory computer-usable or computer-readable medium, such as the storage 26, and including instructions configured to cause the processor 24 to carry out the steps described herein. Thus, the computer-readable program code can comprise software instructions for implementing the functionality of the embodiments described herein when executed on the processor 24. The processor 24, in conjunction with the program modules 114 in the volatile memory 108, may serve as a control system for the server 12 that is configured to, or adapted to, implement the functionality described herein.

An administrator may be able to enter commands and information into the server 12 through one or more input devices, such as, for example, a keyboard (not illustrated); a pointing device, such as a mouse (not illustrated); or a touch-sensitive surface. Other input devices may include a microphone, an infrared (IR) remote control, a joystick, a game pad, a stylus pen, or the like. These and other input devices may be connected to the processor 24 through an input device interface 116 that is coupled to the system bus 104, but can be connected by other interfaces such as a parallel port, an IEEE 1394 serial port, a Universal Serial Bus (USB) port, an IR interface, etc.

The server 12 may also include a communication interface 118 for communicating with the network 18 (FIG. 1), which may comprise, for example, a wired or wireless network interface. The server 12 also preferably includes a video port 120 that interfaces with a display 122 that provides information to the administrator.

Those skilled in the art will recognize improvements and modifications to the preferred embodiments of the present disclosure. All such improvements and modifications are considered within the scope of the concepts disclosed herein and the claims that follow.

What is claimed is:

1. A method for providing relevant information to a mobile device based at least in part on a current location of the mobile device, comprising:
providing an entity structure comprising a plurality of entity records, wherein each entity record of the plurality of entity records corresponds to an entity, is associated with a proper subset of regions of a plurality of regions, and is categorized into at least one category of a plurality of categories based on a service provided by the entity; and
providing, based on the entity structure, a first region category index to the mobile device that is determined to be in a first region of the plurality of regions, the first region category index identifying only those categories in which at least one entity record associated with the first region has been categorized.

2. The method of claim 1, wherein each entity record comprises at least one of entity location data identifying a location of a corresponding entity and entity service area data identifying a service area of the corresponding entity, and wherein the each entity record is associated with the proper subset of regions based on the at least one of the entity location data and the entity service area data.

3. The method of claim 2, further comprising:
providing a first local index structure, the first local index structure corresponding to the first region and identifying only those categories in which at least one entity record associated with the first region has been categorized.

4. The method of claim 3, wherein the first region category index is based on the first local index structure.

5. The method of claim 4, wherein each entity record comprises entity availability data identifying operating hours of the corresponding entity, further comprising:
determining a current time;
wherein the first region category index further identifies only those categories in which at least one entity record associated with the first region has been categorized and in which the at least one entity record comprises service availability data indicating that the corresponding entity is operating at the current time.

6. The method of claim 4, further comprising providing a first entity reference structure corresponding to the first region of the plurality of regions and comprising a plurality of entity lists, each entity list corresponding to a category identified in the first local index structure and comprising a set of entity references to entity records in the entity structure that have been categorized in the corresponding category and are associated with the first region.

7. The method of claim 6, wherein the first local index structure further comprises a plurality of entity list references, each entity list reference referring to one of the plurality of entity lists in the first entity reference structure.

8. The method of claim 6, wherein the first region category index further comprises an entity list reference, the method further comprising:
receiving, from the mobile device, a selection of the entity list reference;
retrieving an entity list referred to by the entity list reference from the first entity reference structure; and
providing the entity list to the mobile device.

9. The method of claim 8, further comprising:
prior to providing the entity list to the mobile device, removing at least one entity reference based on a criteria to generate a filtered entity list, and wherein providing the entity list to the mobile device comprises providing the filtered entity list to the mobile device.

10. The method of claim 3, further comprising:
providing a plurality of local index structures including the first local index structure, each local index structure corresponding to a different region of the plurality of regions and identifying only those categories in which at least one entity record associated with the respective different region has been categorized.

11. The method of claim 10, further comprising providing a plurality of entity reference structures, each entity reference structure corresponding to a particular region of the plurality of regions and comprising a plurality of entity lists, each entity list corresponding to a category identified in the local index structure that corresponds to the particular region, and comprising a set of entity references to entity records in the entity structure that have been categorized in the corresponding category and which are associated with the particular region.

12. The method of claim 11, wherein each local index structure further comprises a plurality of entity list references, each entity list reference referring to one of the plurality of entity lists in the entity reference structure corresponding to the same region to which the each local index structure corresponds.

13. The method of claim 12, further comprising:
receiving, from the mobile device, a selection of a particular entity list reference;
retrieving the entity list referred to by the particular entity list reference from the entity reference structure corresponding to the first region; and
providing the entity list to the mobile device.

14. The method of claim 10, further comprising:
determining that the mobile device has moved from the first region to a second region of the plurality of regions;
generating a second region category index that identifies only those categories in which at least one entity record associated with the second region has been categorized; and
providing the second region category index to the mobile device.

15. The method of claim 14 wherein determining that the mobile device has moved from the first region to the second region comprises receiving, by a second region controller associated with the second region, a request from a first region controller associated with the first region to hand off the mobile device from the first region to the second region.

16. The method of claim 1, wherein providing, based on the entity structure, the first region category index to the mobile device further comprises:
determining that the mobile device has entered the first region; and
in response to the determining, automatically providing the first region category index to the mobile device.

17. A system for providing relevant information to a mobile device based at least in part on a current location of the mobile device, comprising:
a server configured to provide an entity structure comprising a plurality of entity records, wherein each entity record of the plurality of entity records corresponds to an entity, is associated with a proper subset of regions of a plurality of regions, and is categorized into at least one category of a plurality of categories based on a service provided by the entity; and
a first region controller configured to provide, based on the entity structure, a first region category index to the mobile device, which is determined to be in a first region of the plurality of regions, the first region category index identifying only those categories in which at least one entity record associated with the first region has been categorized.

18. The system of claim 17, wherein the server is further configured to:
generate a plurality of local index structures including the first local index structure, each local index structure corresponding to a different region of the plurality of regions and identifying only those categories in which at least one entity record associated with the respective different region has been categorized.

19. The system of claim 18, wherein the server is further configured to distribute each local index structure of the plurality of local index structures to region controllers respectively associated with each of the plurality of different regions.

20. A method for providing relevant information to a mobile device based at least in part on a current location of the mobile device, comprising:
generating an entity structure, the entity structure comprising a plurality of entity records, each entity record being categorized into at least one category and being associated with a particular region of a plurality of regions;
generating a plurality of local index structures, each local index structure corresponding to a different one of the plurality of regions and comprising category entries that correspond to categories in which at least one entity record associated with the different one of the plurality of regions has been categorized;
receiving a request from a mobile device in a first region of the plurality of regions;
in response to the request, providing the local index structure that corresponds to the first region to the mobile device.
